(19) United States
(12) Patent Application Publication
(10) Pub. No.: US 2009/0109194 A1
(43) Pub. Date: Apr. 30, 2009

(54) Touch Screen

(75) Inventors: Wen-Pin Weng, Taipei (TW); Chung-Hsing Tzu, Taipei (TW)

Correspondence Address: Kan Kuan Chuan, P.O. Box 77-13, Taipei, 11161, TW

(73) Assignee: Lunghwa University of Science and Technology, Taoyuan (TW)

(21) Appl. No.: 12/258,466

(22) Filed: Oct. 27, 2008

Related U.S. Application Data
(60) Provisional application No. 60/983,209, filed on Oct. 28, 2007.

(51) Int. Cl. G06F 3/042

(52) U.S. Cl. 345/175

(57) ABSTRACT

The present invention provides the system design of the positioning analysis of a touch screen. It receives the signals from the wave sensor that employs the concept of the reflection of the light, sound, or supersonic, and the signals are calculated by the core logic circuit to obtain the position coordinate of an object. And then a display module is employed to show the moving path of the object in the manner of an image or line on a screen. The wave sensor may be implemented by a CMOS optical image sensor, infrared sensor, or supersonic sensor. The CMOS (Complementary metal oxide semiconductor) optical image sensor may additionally comprise fibers to transmit the optical wave to the CMOS sensor smoothly.

### BACKGROUND OF THE PRESENT INVENTION

1. Field of Invention

The present invention relates to a touch screen, particularly to the touch screen employing the concept of the detection of the wave reflection.

2. Description of Related Arts

The conventional touch screen may be classified to the resister-type and capacitor-type. The resister-type touch screen includes a polyester layer on the surface with a conducting metal film inside. The bottom of the touch screen is a glass panel covered by the conducting material stuck on the CRT (cathode-ray tube) or LCD (liquid crystal display). There are tiny “separating points” formed by polyester to separate the glass panel and the polyester layer. There is a controller alone the X axis and Y axis of the glass panel separately which can apply small voltage gradients. Whenever a finger touches the screen, the two conducting layers are pressed to touch each other. Therefore, the electronic apparatus can detect the X-Y coordinate of the touch point. The capacitor-type touch screen comprises two layers of conduction material on both sides, and an anti-scrape film is applied on the outer side. The electrode plates around the glass panel can generate uniform low electrical field on the outside conducting layer, and the inside conducting layer can provide electromagnetic shielding and reduce noise. Whenever a finger touches the screen, the capacitor coupling is formed in the electrical filed of the outside conducting layer so as to absorb some small current. The electrode plates are responsible for measuring the currents coming from every corner, and then the controller position the coordinate of the finger.

However, no matter it is the resistor-type or capacitor-type touch screen, the polyester or conducting layer is aging under the condition of pressing for a long time to cause the sensitivity reduction. The usage time is not long. In the circumstance of the polyester or conducting layer aging, the ability of positioning analysis is reduced so that it is necessary to touch many times. Or it can work only by one finger, one point positioning. If the multi-point touching, two or more touch points touching, is performed, the points may not be distinguished, or the error caused by the deviation of the positioning analysis is so big to bother the user a lot.

Afterwards, some people developed the touch screen employing the finger detection according to the infrared blocking. But this kind of system needs rows (or lines) of transmitters and receivers in pair along the contour of the screen to detect the interfering of an object. There is a drawback of high cost as well for the system.

Therefore, the present invention provides a touch screen employing the concept of the wave reflection detection.

### SUMMARY OF THE PRESENT INVENTION

The present invention receives the signals from the wave sensor that employs the concept of the reflection of the light, sound, or supersonic, and the signals are calculated by the core logic circuit to obtain the position coordinate of an object. And then a display module is employed to show the moving path of the object in the manner of an image or line on a screen. Beside the advantage of the fast transmission of signals, it can improve the drawback of the transformation damage caused by undergoing the repeated stress for the conventional touch screen so as to extend the usage time of the product, and effectively reduce the manufacturing cost to reach the goal of popularization.

### BRIEF DESCRIPTION OF THE DRAWINGS

FIG. 1 is the embodiment diagram of the touch screen comprising the CMOS optical image sensor according to the present invention.

FIG. 2 is the embodiment diagram as the system shown in FIG. 1, additionally including fibers.

FIG. 3A is the embodiment diagram of the touch screen comprising the infrared image signal sensor according to the present invention (the infrared transmitter and receiver are integrated in a single module).

FIG. 3B is the embodiment diagram of the touch screen comprising the infrared image signal sensor according to the present invention (the infrared transmitter and receiver are provided separately).

FIG. 4A is the embodiment diagram of the touch screen comprising the supersonic image signal sensor according to the present invention (the infrared transmitter and receiver are integrated in a single module).

FIG. 4B is the embodiment diagram of the touch screen comprising the supersonic image signal sensor according to the present invention (the infrared transmitter and receiver are provided separately).

FIG. 4C is the embodiment diagram of the touch screen comprising the supersonic image signal sensor according to the present invention (the infrared transmitter and receiver locate at sides opposite to each other).

### DETAILED DESCRIPTION OF THE PREFERRED EMBODIMENT

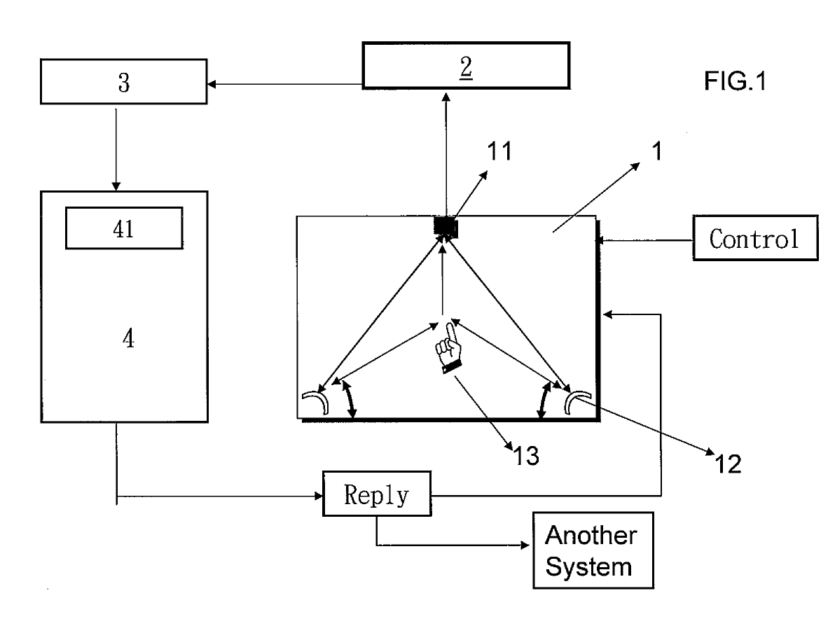

Please referring to FIG. 1, there is a screen 1 and a CMOS optical image sensor 11 locates at the proper position on the screen 1. There are two convex mirrors 12 at the proper positions corresponding to the CMOS optical image sensor 11. The arrangement of the devices mentioned above forms an image sensing net. When an object 13 enters the image sensing net, the CMOS optical image sensor 11 retrieves the object images through or not through the convex mirrors 13 respectively. The object images are transmitted to the CMOS image retrieving circuit 2 which is electrically connected to the CMOS optical image sensor 11. And then the object images are transmitted to the image analysis circuit 4 through the noise filter 3. The two object images are compared by the core logic circuit to calculate for positioning the object 13 corresponding to the screen 1.

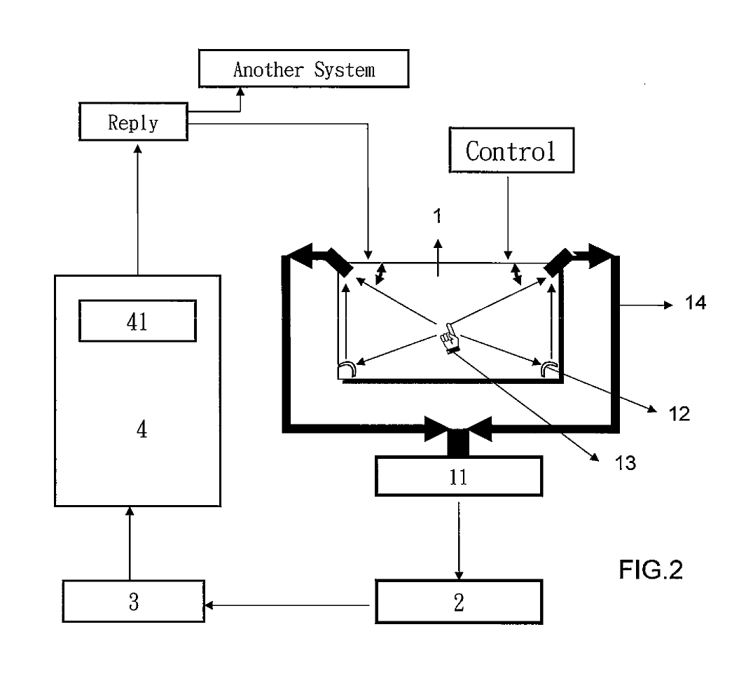

Referring to FIG. 2, it is another embodiment of the system shown in FIG. 1. The CMOS optical image sensor 11 is excluded from the screen 1 system, and fibers 14 connects the screen 1 and the CMOS optical image sensor 11 so that the image analysis positioning method can reach the better result for touching-and-controlling for various screen 1 system assemble and appearance.

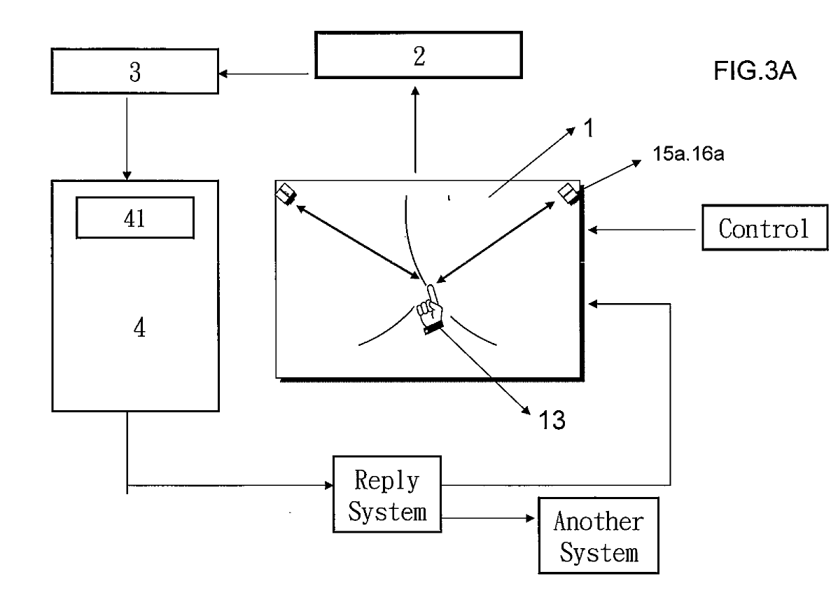

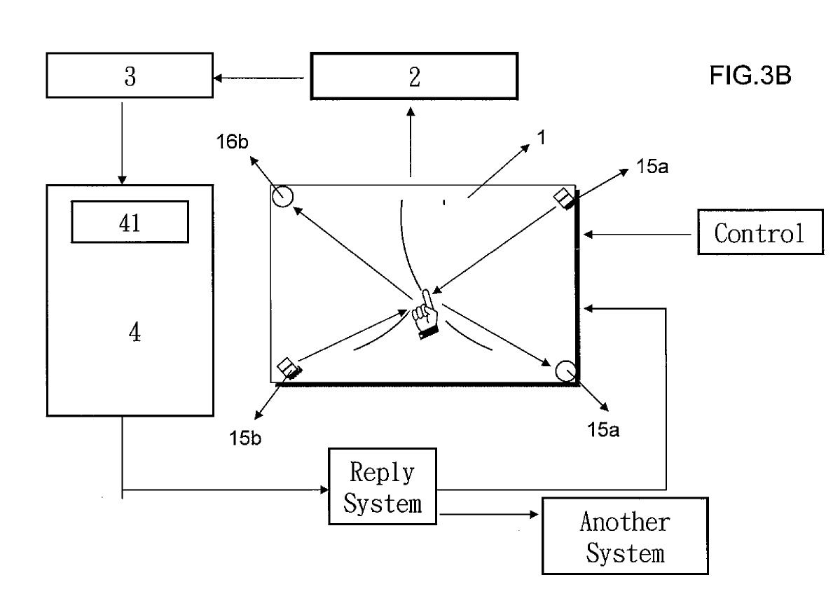

Referring to FIG. 3A and 3B, there is a screen 1 as well, and there are the first infrared transmitter 15a, the second infrared transmitter 15b, the first infrared receiver 16a, and the second infrared receiver 16b locating at the proper positions. An image sensing net is formed by the infrared transmitters 15a and 15b, and infrared receivers 16a and 16b. The infrared transmitters 15a and 15b, and infrared receivers 16a and 16b are electrically connected to the infrared image signal retrieving circuit. When an object 13 enters the image sensing net, interfering reflection happens among the infrared transmitters 15a and 15b, and infrared receivers 16a and 16b, and the interfering reflection signals are transmitted to the infrared image signal retrieving circuit 2. The interfering reflection signals are filtered by the noise filter 3 and transmitted to the image analysis circuit 4 to perform analysis calculation for positioning the object 13 corresponding to the screen.

For the mentioned above, the infrared transmitter and receiver can be integrated in a single device or provided separately.

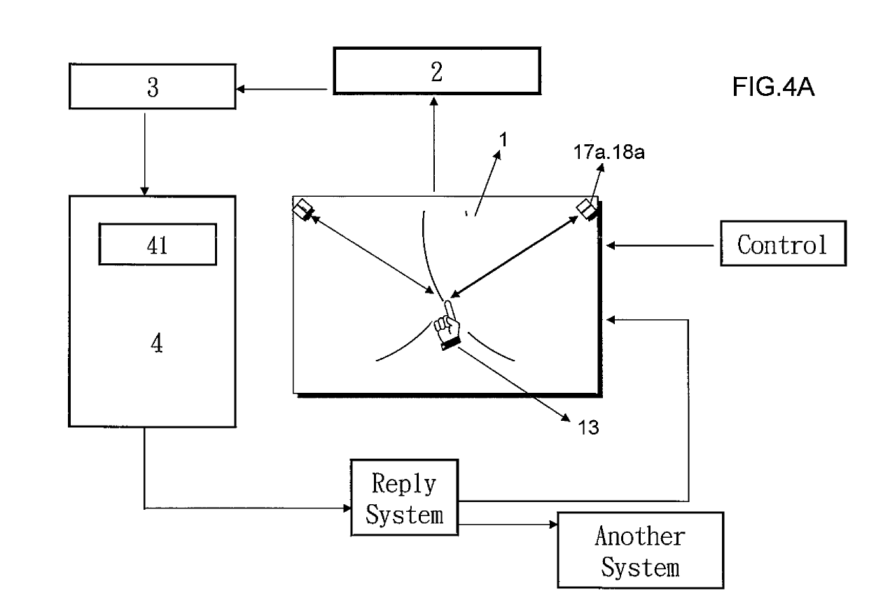

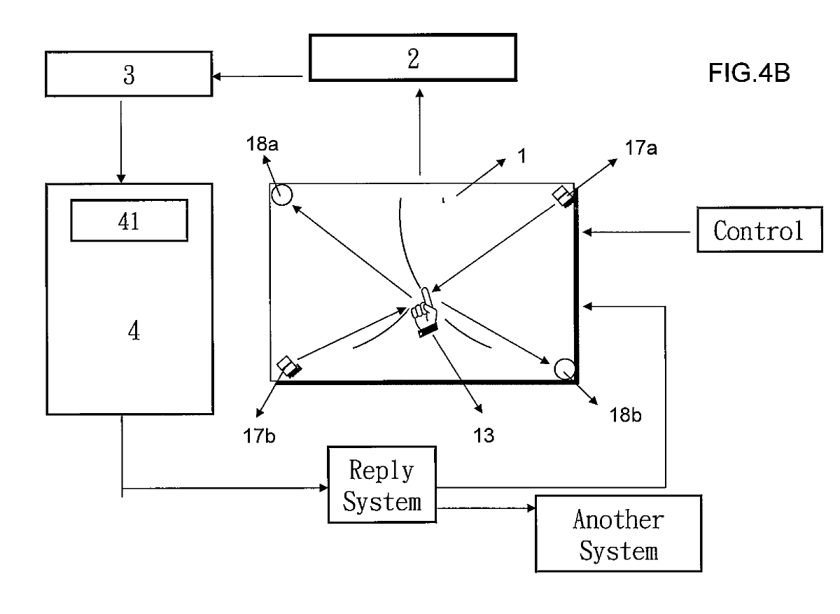

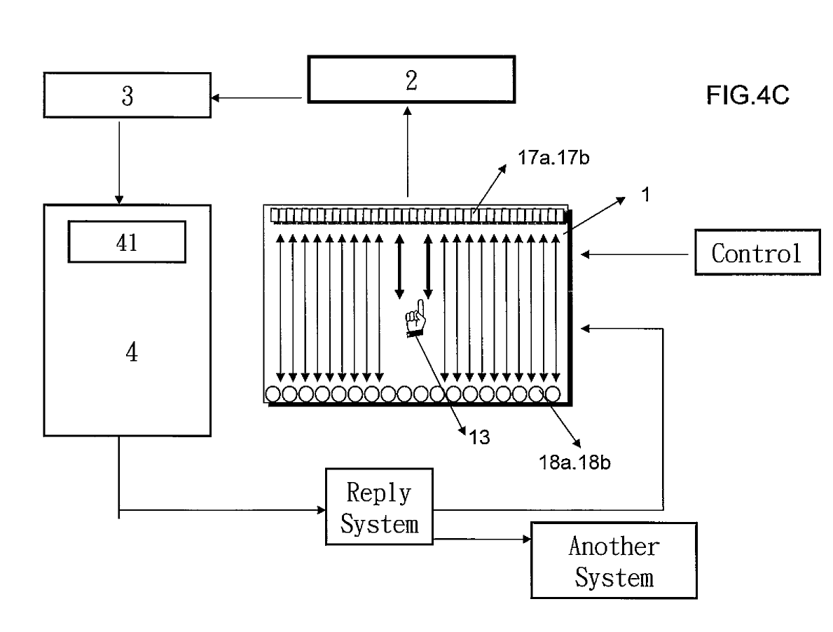

Referring to FIGS. 4A, 4B, and 4C, there is a screen 1 as well, and there are the first supersonic transmitter 17a, the second supersonic transmitter 17b, the first supersonic receiver 18a, and the second supersonic receiver 18b locating at the proper positions. An image sensing net is formed by the supersonic transmitters 17a and 17b, and supersonic receivers 18a and 18b. The supersonic transmitters 17a and 17b, and supersonic receivers 18a and 18b are electrically connected to the infrared image signal retrieving circuit. When an object 13 enters the image sensing net, interfering reflection happens among the supersonic transmitters 17a and 17b, and supersonic receivers 18a and 18b, and the interfering reflection signals are transmitted to the supersonic image signal retrieving circuit 2. The interfering reflection signals are filtered by the noise filter 3 and transmitted to the image analysis circuit 4 to perform analysis calculation for positioning the object 13 corresponding to the screen.

For the mentioned above, the supersonic transmitter and receiver can be integrated in a single device or provided separately. The supersonic transmitter and receiver provided separately can locate at sides opposite to each other.

The technologies disclosed by the present invention can enable the person skilled in the art to accomplish according to the disclosure. And the implementation and improvement of the present invention are patentable as well for patent application according to the law. The embodiments mentioned above are not enough to cover the scope of the claim. What is claimed refers to the following.

What is claimed is:

1. A touch screen, comprising:
A screen;
A CMOS optical image sensor, dispose at a first position;
A first convex mirror and a second convex mirror, disposed at a second and a third position respectively;
A CMOS image retrieving circuit electrically connected to the CMOS optical image sensor to retrieve a first object image detected by the CMOS optical image sensor through the convex mirrors and a second object image detected by the CMOS optical image sensor not through the convex mirrors; and
An image analysis circuit electrically connected to the CMOS image retrieving circuit, comparing the first and second object images to calculate for positioning an object, corresponding the first and second object images,

2. The touch screen according to claim 1, further comprising a noise filter electrically connected to the CMOS optical image sensor and the image analysis circuit.

3. The touch screen according to claim 1, further comprising fibers electrically connected to the screen and the CMOS optical image sensor.

4. A touch screen, comprising:
A screen;
A first infrared transmitter, a second infrared transmitter, a first infrared receiver, and a second infrared receiver, disposed at a first, second, third, and fourth position respectively;
An infrared image signal retrieving circuit, electrically connected to the infrared transmitters and infrared receivers; and
An image analysis circuit, positioning an object in the screen according to an infrared interfering result of an object to calculate.

5. The touch screen according to claim 4, further comprising a noise filter electrically connected to the infrared image signal sensor and the image analysis circuit.

6. The touch screen according to claim 4, wherein the first infrared transmitter comprises the first infrared receiver, and the second infrared transmitter comprises the second infrared receiver.

7. A touch screen, comprising:
A screen;
A first supersonic transmitter, a second supersonic transmitter, a first supersonic receiver, and a second supersonic receiver, disposed at a first, second, third, and fourth position respectively;
An supersonic image signal retrieving circuit, electrically connected to the supersonic transmitters and supersonic receivers; and
An image analysis circuit, positioning an object in the screen according to an supersonic reflection result of an object to calculate.

8. The touch screen according to claim 7, further comprising a noise filter electrically connected to the supersonic image signal sensor and the image analysis circuit.

9. The touch screen according to claim 7, wherein the first supersonic transmitter comprises the first supersonic receiver, and the second supersonic transmitter comprises the second supersonic receiver.
